(19) United States
(12) Patent Application Publication
(10) Pub. No.: US 2023/0008146 A1
(43) Pub. Date: Jan. 12, 2023

(54) CALIBRATING A VIRTUAL FORCE SENSOR OF A ROBOT MANIPULATOR

(71) Applicant: Franka Emika GmbH, München (DE)

(72) Inventor: Andreas Spenninger, Karlsfeld (DE)

(21) Appl. No.: 17/784,830

(22) PCT Filed: Dec. 16, 2020
(86) PCT No.: PCT/EP2020/086423

§ 371 Date: Jun. 13, 2022

(30) Foreign Application Priority Data
Dec. 17, 2019 (DE) 10 2019 134 665.7

(51) Int. Cl. G01L 27/00; G01L 5/00; B25J 9/16

(52) U.S. Cl. CPC G01L 27/002; G01L 5/0061; B25J 9/1633; B25J 9/1692

(57) ABSTRACT

A method of calibrating a virtual force sensor of a robot manipulator, wherein in a plurality of poses, the method comprises: applying an external wrench to the robot manipulator ascertaining an estimate of the external wrench, ascertaining a respective cost function based on a difference between the determined estimate of the external wrench and a specified external wrench, ascertaining a respective calibration function by minimizing the respective cost function, and storing the respective calibration function in a data set of all calibration functions with assignment of the respective calibration function to a respective pose for which the respective calibration function was ascertained.

### CROSS-REFERENCE TO RELATED APPLICATIONS

The present application is the U.S. National Phase of PCT/EP2020/086423, filed on 16 Dec. 2020, which claims priority to German Patent Application No. 10 2019 134 665.7, filed on 17 Dec. 2019, the entire contents of which are incorporated herein by reference.

### BACKGROUND

### Field

The invention relates to a method for calibrating a virtual force sensor of a robot manipulator and a robot system with a robot arm and with a control unit for applying this calibration.

### SUMMARY

The object of the invention is to improve the execution of a virtual force sensor on a robot manipulator or robot arm.

The invention results from the features of the independent claims. Advantageous developments and configurations are the subject matter of the dependent claims.

A first aspect of the invention relates to a method for calibrating a virtual force sensor of a robot manipulator, the virtual force sensor being used to determine an external wrench acting on the robot manipulator based on torques determined by torque sensors in joints of the robot manipulator, wherein the robot manipulator is moved or guided manually in a large number of poses and in each of the poses the following steps are performed:
applying a specified external wrench to the robot manipulator,
ascertaining a respective estimate of the external wrench based on an inverted or pseudo-inverted of the transpose of the Jacobian matrix applicable to the current pose and based on an external torque vector, wherein the external torque vector is based on the torques determined by the torque sensors in the joints of the robot manipulator and is determined based on expected torques acting on the robot manipulator,
ascertaining a respective cost function based on a norm of a difference between the determined estimate of the external wrench and the specified external wrench or based on a difference of a norm of the determined estimate of the external wrench and a norm of the specified external wrench,
ascertaining a respective calibration function by minimizing the respective cost function, the calibration function being used to adjust an external wrench currently determined during subsequent operation, and
storing the respective calibration function in a data set of all calibration functions with assignment of the respective calibration function to the respective pose for which the respective calibration function was determined.

A pose of the robot manipulator indicates, in particular, the entirety of the positions and the orientations of all members including an end effector, if present, of the robot manipulator. If the complete information about a pose is known, the robot manipulator can be moved into a unique “attitude” by all drives, especially on its joints.

An external wrench indicates forces and/or torques acting on the robot manipulator from the environment and vice versa, the external wrench generally having three components for forces and three components for torques. The specified external wrench is preferably the same across all poses of the robot manipulator, it is namely constant. Alternatively, a different wrench is preferably provided for at least two of the poses, which advantageously also takes into account those poses that would behave at least partially singularly with a constant wrench, namely in at least some of the joints of the robot manipulator connecting the members an external force of the wrench, is transmitted linearly through the joint toward the nearest proximal member without creating a torque in the joint. An example of such a singular pose is when all members of the robot manipulator are aligned on a common straight line and the external wrench has only one force vector in the direction of that same common straight line to the base of the robot manipulator.

As this external wrench is applied to the robot manipulator, an estimate of this external wrench is ascertained by the virtual force sensor. This is done with the help of torque sensors arranged, in particular, but not necessarily exclusively, on the joints. The torque sensors on the joints can be selected from the variety of torque sensors known in the prior art. In particular, the torque sensors are mechanical torque sensors in which a stretching of a flexible, elastic material, for example, in spokes of the respective torque sensor, is detected, it being possible to infer an applied torque from knowledge of the material constants. Furthermore, it is possible, in particular, to measure a current strength present in an electric motor and, from this, to deduce a torque present in the joint. The respective torque in a joint thus detected is typically based on a large number of causes. In the case of a movement of the robot manipulator, a first part of the torque results from the kinematic forces and torques, in particular, the Coriolis acceleration and the centrifugal acceleration. Another part of the measured torque is due to the influence of gravity, independent of the movement of the robot manipulator.

While the torques at the joints are detected directly or indirectly by a measurement by the torque sensors, these lead to the expected torques due to the influence of gravity and kinematically caused forces and torques. That is, depending on the current speed of movement, on the current acceleration of the robot manipulator, and on the mass distribution and the current pose of the robot manipulator (gravity influence), these torques can theoretically be determined at the torque sensors of the robot manipulator as expected torques and be deducted from the measured torques at the respective torque sensors. This is preferably done in a momentum observer, which provides the external torques.

The (pseudo) inverse of the transpose of the Jacobian matrix is required in order to derive an estimate of the specified external wrench with its current reference point from the external torques determined in this way. The pseudo-inverse (instead of the inverse itself) is necessary, in particular, when the robot manipulator is a redundant manipulator, namely at least two of the joints connecting the members have mutually redundant degrees of freedom. In a redundant robot manipulator, in particular, members of the robot manipulator can be moved without an orientation and/or a position of the end effector of the robot manipulator changing.

The Jacobian matrix basically links the angular velocities at the joints to the translational and rotational velocities at any point, in particular, at a distal end of the robot manipulator. In principle, however, it is irrelevant whether speeds are actually considered; the Jacobian matrix can also be used for the relationship between the torques at the joints and the forces and torques at any specified point.

The transpose of the Jacobian matrix J, namely J^{T}, correlates the external wrench Fₑₓₜ to the vector of the determined external torques τₑₓₜ as follows:

τₑₓₜ=J^{T}Fₑₓₜ.

After rearranging this equation using the (pseudo) inverse of the transpose of J, denoted as (J^{T})^{#}, the following applies to the estimation of the external wrench F_{ext,est} based on the vector of the determined external torques τₑₓₜ:

F_{ext,est}=(J^{T})^{#}τₑₓₜ.

The direction and magnitude of the specified external wrenches are known by definition since the known magnitude of specified external wrenches is also applied. With the above calculation, the estimate of the external wrench in each individual pose of the robot manipulator in which an external wrench is applied is also known. A respective cost function is then ascertained based on a norm of a difference between the determined estimate of the external wrench and the specified external wrench or based on a difference of a norm of the determined estimate of the external wrench and a norm of the specified external wrench.

In the first case, namely if the ascertaining of a respective cost function is performed based on a norm of a difference between the determined estimate of the external wrench and the specified external wrench, a cost function K is determined according to the following scheme:

K=f(∥F_{ext,est}−F_{ext,real}∥).

In the second case, namely if the ascertaining of a respective cost function is performed based on a difference of a norm of the determined estimate of the external wrench and a norm of the specified external wrench, a cost function is determined according to the following scheme:

K=f(∥F_{ext,est}∥−∥F_{ext,real}∥).

While the first case is preferably used for the general case of several components of forces and/or torques in the external wrench, the second case is particularly suitable for the consideration of a single component, in particular, when the specified external wrench is always in the same direction, which is particularly the case when suspending an external load with a specified mass.

Furthermore, a respective calibration function is ascertained by minimizing the respective cost function, with the calibration function being used to adapt an external wrench currently determined during subsequent operation, namely the aim is to solve the rule minK(x) according to the variables and/or parameters x of the calibration function.

The steps of ascertaining an estimate of the external wrench, ascertaining a respective calibration function by ascertaining a respective cost function and minimizing it, and storing the respective calibration function are preferably carried out by a computing unit. The computing unit is connected, in particular, to the robot manipulator. The computing unit is particularly preferably arranged on the robot manipulator itself, in particular, on a pedestal or a base of the robot manipulator.

It is an advantageous effect of the invention that instead of calibrating each of the torque sensors of the robot manipulator, all of the torque sensors are pose-dependently calibrated in their function as virtual force sensors, taking into account the expected torques on the robot manipulator, and thus all uncertainties in the mass distribution of the robot manipulator, peculiarities of the torque sensors and other effects are all taken into account. The data set of all calibration functions makes it possible to apply an individual calibration to the virtual force sensor of the robot manipulator for a specific pose of the robot manipulator.

According to an advantageous embodiment, the specified external wrench is applied to the robot manipulator at a distal end of the robot manipulator. An end effector is preferably arranged at the distal end of the robot manipulator. Since contact forces of the robot manipulator, apart from unexpected collisions, typically take place between the end effector and an object from the environment of the robot manipulator, this embodiment advantageously takes this fact into account, so that the calibration, in particular takes place with regard to a wrench between the end effector at the distal end of the robot manipulator and the environment of the robot manipulator.

The large number of poses of the robot manipulator is preferably defined by an equidistant grid of positions for a reference point of the robot manipulator in relation to a ground-fixed coordinate system, whereby advantageously at least approximately all possible positions of the reference point of the robot manipulator (possibly with several poses per grid point for a redundant robot manipulator) are taken into account, but also a very high number of grid points must be considered.

According to a further advantageous embodiment, a task is therefore specified for the robot manipulator, the task is analyzed and working points to be traveled through are identified when the task is carried out, with the respective poses of the robot manipulator being selected in such a way that one of the working points and a reference point of the robot manipulator match in a respective pose. The reference point of the robot manipulator is, in particular, a reference point at the distal end of the robot manipulator, and is, in particular, arranged in a precise manner at the end effector. The reference point is, in particular, connected to the robot manipulator in a body-fixed manner, in particular, to a location on the surface of the robot manipulator, namely it does not move relative to this selected location, even when the robot manipulator moves. With this embodiment, the calibration is advantageously specifically tailored to a task to be performed by the robot manipulator and the number of grid points is significantly reduced.

According to a further advantageous embodiment, the robot manipulator is a redundant robot manipulator and the estimate of the external wrench is determined using the pseudo inverse of the transpose of the current Jacobian matrix for the respective pose of the robot manipulator. A redundant robot manipulator has mutually redundant degrees of freedom. This means, in particular, that members of the robot manipulator can move without changing the orientation of a specific member, in particular, an end effector of the robot manipulator, and/or a position of a specified reference point, in particular, at the distal end of the robot manipulator.

According to a further advantageous embodiment, at least for a subset of the plurality of poses of the robot manipulator, the redundant robot manipulator is moved in its null space over a plurality of poses and a separate calibration function is determined and stored for each of the plurality of poses. Changing inaccuracies in the estimation of an external wrench due to a pose change of the robot manipulator in its null space are also advantageously taken into account by this embodiment.

According to a further advantageous embodiment, the respective cost function is minimized by a gradient-based method. The task of minimizing the cost function, namely minK(x), is carried out, in particular, with a search step s=−α∇K, wherein α is the length of the current search step, s is the search direction, and ∇ is the gradient of the cost function K(x), depending on variables and/or parameters x of the calibration function K(x). The parameter a is preferably determined using a line search method, the so-called “line search”, so that the local minimum is searched for in the possibly higher-dimensional parameter space of x after the search direction has been determined along this search direction and, when this local minimum is reached, a new search direction is determined by determining a new current gradient of the cost function determined there (∇K). As an alternative, the gradient-based search method is preferably expanded to include information about the curvature of the cost function, and quadratic optimization is thus used. The use of a gradient-based method advantageously provides a deterministic algorithm with sufficiently rapid convergence in the direction of a local or ideally global optimum of the cost function in order to minimize it.

According to a further advantageous embodiment, the respective cost function is minimized by a genetic or evolutionary method. Genetic algorithms or evolutionary algorithms are based, in particular, on the random principle, according to which starting points of x are chosen more or less randomly and/or values of x with potential for convergence to a local or global minimum are recombined. While genetic and evolutionary algorithms have a higher chance of finding the global minimum (as opposed to a local minimum), their computing time can exceed gradient-based methods considerably.

According to a further advantageous embodiment, the specified external wrench is applied to the robot manipulator by attaching a load with a specified mass to the robot manipulator. With constant and known gravity, it is very reliably ensured by attaching a load with a specified mass that the external wrench always acts in the same direction with respect to an earth-fixed coordinate system and always with the same strength.

According to a further advantageous embodiment, the specified external wrench is applied to the robot manipulator by connecting a mechanical spring of the robot manipulator to a support in such a way that the mechanical spring is pre-tensioned and exerts a force on the robot manipulator. The mechanical support is preferably arranged on a second manipulator, preferably on an end effector of the second manipulator. By using a spring, any values of a force component of the external wrench can advantageously be specified continuously by stretching the spring over a specific linear range of the spring.

According to a further advantageous embodiment, the application of the specified external wrenches on the robot manipulator takes place by moving the robot manipulator, so that specified accelerations occur on the robot manipulator due to the inertial mass of the robot manipulator. According to this specific embodiment, the torques from the movement of the robot manipulator are accordingly not taken into account among the expected torques, since precisely these torques are to be detected and an estimate of the external wrench is determined from them. Advantageously, according to this embodiment, neither a load with additional mass is required on the robot manipulator nor the connection to a spring nor the application of other external forces and/or torques is necessary, since the movement that can be carried out by the robot manipulator itself is used to calibrate the virtual force sensor.

A further aspect of the invention relates to a robot system with a robot arm and with a control unit, the control unit being designed to carry out a virtual force sensor on the robot arm, the virtual force sensor being used to determine an external wrench acting on the robot manipulator and the external wrench being based on torques determined by torque sensors in the joints of the robot arm and on expected torques acting on the robot arm and based on the inverted or pseudo-inverted of the transpose of the respective pose-dependent current Jacobian matrix, the control unit being designed to apply pose-dependent calibration on the currently determined external wrench, and to generate the calibration from the data set of all calibration functions generated by a method by selecting a specific calibration function associated to the respective current pose of the robot arm, or to generate at least two of the calibration functions by generating an interpolation, wherein the respective poses of the at least two determined ones of the calibration functions are closest to the respective current pose of the robot arm.

Advantages and preferred developments of the proposed robot system result from an analogous and corresponding transfer of the statements made above in conjunction with the proposed method.

Further advantages, features, and details will be apparent from the following description, in which—possibly with reference to the drawings—at least one example embodiment is described in detail. Identical, similar, and/or functionally identical parts are provided with identical reference numerals.

### BRIEF DESCRIPTION OF THE DRAWINGS

In the drawings:

FIG. 1 shows a method for calibrating a virtual force sensor of a robot manipulator according to an example embodiment of the invention;

FIG. 2 shows a robot manipulator on which the method according to FIG. 1 is carried out; and

FIG. 3 shows a robot system for using the result of the calibration according to FIG. 1 according to a further example embodiment of the invention.

The illustrations in the figures are schematic and not to scale.

### DETAILED DESCRIPTION

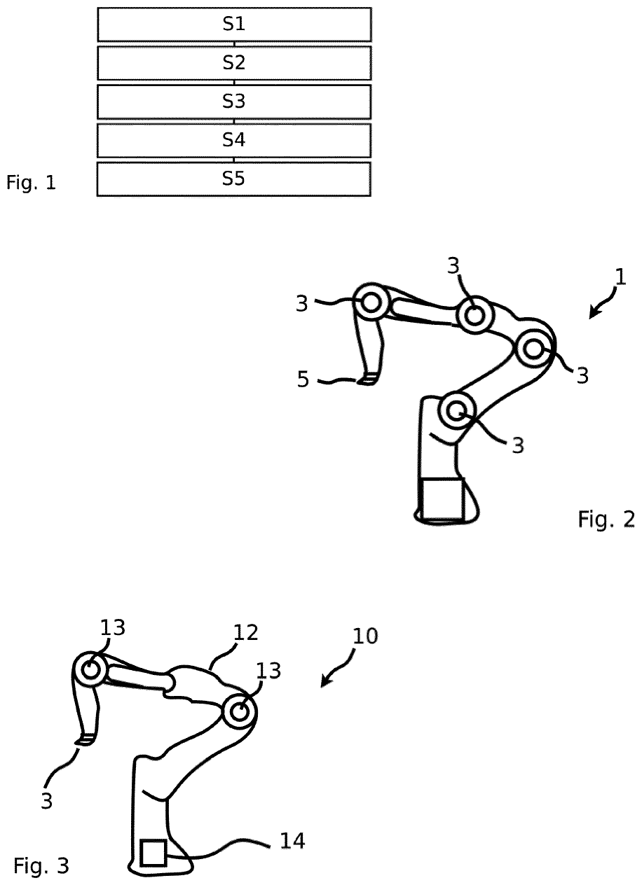

FIG. 1 shows a method for calibrating a virtual force sensor of a robot manipulator 1. The robot manipulator 1 is moved into a large number of poses by appropriately controlling its drives. This is a redundant robot manipulator 1. Therefore, for a common position of the distal end 5 of the robot manipulator 1, a large number of poses are assumed by the redundant robot manipulator 1, in that the robot manipulator 1 is moved in its null space over a large number of poses. In each of the poses, the robot manipulator 1 is kept motionless for a certain period of time to repeat the following steps, that is, at each of the poses: initially, at operation S1 a specified external wrench with specified forces and torques is applied to the distal end 5 of the robot manipulator 1. This is done by an external test unit (not shown in FIG. 1). This is followed at operation S2 by ascertaining an estimate of the external wrench F_{ext,est} based on an inverted or pseudo-inverted of the transpose of the Jacobian matrix applicable to the current pose, namely (J^{T})^{#} and based on an external torque vector τₑₓₜ, wherein the external torque vector τₑₓₜ is based on the torques determined by the torque sensors 3 in the joints of the robot manipulator 1 and is determined based on expected torques acting on the robot manipulator 1:

F_{ext,est}=(J^{T})^{#}τₑₓₜ.

The pseudo-inverse of the transpose of the Jacobian matrix applicable to the current pose, namely (J^{T})^{#} instead of (J^{T})⁻¹, is used because a redundant robot manipulator 1 is involved. At operation S3, a respective cost function is then determined based on a norm of a difference between the determined estimate of the external wrench and the specified external wrench. The cost function is determined for each of the poses of the robot manipulator 1 as:

K=∥F_{ext,est}−F_{ext,real}∥₂².

That is, the two-norm of the difference between the estimate of the external wrench F_{ext,est} and the a priori known specification of the external wrench F_{ext,real} is squared. The scalar result of this rule corresponds to the cost function. Furthermore, at operation S4 the determination of a respective calibration function follows by minimizing the respective cost function using a gradient-based method. The task minK(x) is carried out, in particular, with a search step s=−α∇K, wherein α is the length of the current search step, s is the search direction, and ∇ is the gradient of the cost function K(x), depending on variables and/or parameters x of the calibration function L(x). The parameter a is preferably determined using a line search method, the so-called “line search”, so that the local minimum is searched for in the possibly higher-dimensional parameter space of x, after the search direction has been determined, along this search direction and, when this local minimum is reached, its new search direction is determined by determining gradients of the cost function (∇K). As a result, a set of variables and/or a set of parameters x₀ is available which, when used to adjust the estimate of the external wrench F_{ext,est} with the calibration function L(x₀), leads to a minimal cost function K(x₀). Finally, at operation S5 the respective calibration function valid for the respective pose of the robot manipulator 1 is stored in a data set of all calibration functions, with assignment of the respective calibration function to the respective pose for which the respective second calibration function was determined. Such a robot manipulator 1, on which this method is carried out, is shown in FIG. 2. The reference symbols of FIG. 2 also apply to the above explanation of FIG. 1.

FIG. 2 shows such a robot manipulator 1 with its components, the torque sensors 3 and its distal end 5 of the robot manipulator 1. The redundant degrees of freedom of the robot manipulator 1 are symbolized by a large number of joints with mutually parallel joint axes. The method as described under FIG. 1 is carried out on this robot manipulator 1. Reference is made to the explanations for FIG. 1.

FIG. 3 shows a robot system 10 with a robot arm 12 and with a control unit 14. The robot system 10 is shown symbolically with a different robot arm 12 in FIG. 3 than the robot manipulator 1 from FIG. 1. This shows that the calibration according to the explanations for FIG. 1 and FIG. 2 can be transferred to a further robot system 10 without the calibration having taken place on the latter. The control unit 14 of the robot system 10 is arranged on a base of the robot arm 12 and executes a virtual force sensor on the robot arm 12, the virtual force sensor being used to determine an external wrench currently acting on the robot arm 12, and the external wrench is determined based on torques determined by torque sensors 13 in joints of the robot arm 12 torques and based on expected torques acting on the robot arm 12 and based on the inverse or pseudo-inverse of the transpose of the respective pose-dependent current Jacobian matrix. The control unit 14 also applies a pose-dependent calibration function to the currently determined external wrench, wherein the calibration function is determined from the data set of all second calibration matrices generated according to the explanations relating to FIG. 1, by selecting a specific calibration function, which is associated to the respective current pose of the robot arm 12, namely which is closest to the same.

Although the invention has been further illustrated and described in detail by way of preferred example embodiments, the invention is not limited by the disclosed examples, and other variations can be derived therefrom by a person skilled in the art without departing from the scope of protection of the invention. It is therefore clear that a plurality of possible variations exists. It is also clear that embodiments mentioned by way of example actually only represent examples, which are not to be construed in any way as limiting the scope of protection, the possible applications, or the configuration of the invention. Rather, the preceding description and the description of the figures enable a person skilled in the art to implement the example embodiments, wherein a person skilled in the art, knowing the disclosed concept of the invention, can make various changes, for example with respect to the function or arrangement of individual elements cited in an example embodiment, without leaving the scope of protection as defined by the claims and their legal equivalents, such as more extensive explanations in the description.

### LIST OF REFERENCE NUMERALS

1 robot manipulator

3 torque sensors

5 distal end of the robot manipulator

10 robot system

12 robot arm

13 torque sensors

15 control unit

S1 applying

S2 ascertaining

S3 ascertaining

S4 ascertaining

S5 storing

1. A method of calibrating a virtual force sensor of a robot manipulator, wherein the virtual force sensor is used to determine an external wrench acting on the robot manipulator based on torques determined by torque sensors in joints of the robot manipulator, wherein the robot manipulator is moved or guided manually in a plurality of poses and in each of the poses the method comprises:
applying a respective specified external wrench to the robot manipulator;
ascertaining a respective estimate of the external wrench based on an inverted or pseudo-inverted of the transpose of the Jacobian matrix applicable to a current pose and based on an external torque vector, wherein the external torque vector is based on the torques determined by the torque sensors in the joints of the robot manipulator and is determined based on expected torques acting on the robot manipulator;
ascertaining a respective cost function based on a norm of a difference between the ascertained respective estimate of the external wrench and the respective specified external wrench or based on a difference of a norm of the ascertained respective estimate of the external wrench and a norm of the respective specified external wrench;
ascertaining a respective calibration function by minimizing the respective cost function, the respective calibration function being used to adjust an external wrench currently determined during subsequent operation; and
storing the respective calibration function in a data set of all calibration functions with assignment of the respective calibration function to a respective pose for which the respective calibration function was ascertained.

2. The method according to claim 1, wherein the method comprises:
specifying a task for the robot manipulator;
analyzing the task and identifying working points to be traveled when a task is carried out; and
selecting respective poses of the robot manipulator in such a way that a respective one of the working points and a reference point of the robot manipulator match each other in a respective pose.

3. The method according to claim 1, wherein the robot manipulator is a redundant robot manipulator and the estimate of the external wrench is ascertained using the pseudo-inverse of the transpose of the current Jacobian matrix for the respective pose of the robot manipulator.

4. The method according to claim 3, wherein at least for a subset of the plurality of poses of the robot manipulator, the method comprises:
moving the redundant robot manipulator in its null space over a plurality of poses;
determining a separate calibration function; and
storing the calibration function for each of the plurality of poses.

5. The method according to claim 1, wherein the respective cost function is minimized by a gradient-based method.

6. The method according to claim 1, wherein the respective cost function is minimized by a genetic method or an evolutionary method.

7. The method according to claim 1, wherein application of the specified external wrench to the robot manipulator takes place by suspending a load having a specified mass to the robot manipulator.

8. The method according to claim 1, wherein the application of the specified external wrench to the robot manipulator takes place by connecting a mechanical spring of the robot manipulator to a support in such a way that the mechanical spring is pre-tensioned and exerts a force on the robot manipulator.

9. The method according to claim 1, wherein the application of the specified external wrenches on the robot manipulator takes place by moving the robot manipulator, so that specified accelerations due to inertial mass of the robot manipulator take place on the robot manipulator.

10. The method according to claim 1, wherein the method comprises:
generating a pose-dependent calibration function from the data set of all the calibration functions by selecting a specific calibration function associated with a respective current pose of the robot manipulator or by generating an interpolation from at least two specific ones of all the calibration functions, wherein respective poses of the at least two specific ones of the calibration functions are closest to the respective current pose of the manipulator; and
applying the pose-dependent calibration on a currently determined external wrench acting on the robot manipulator.

11. A robot system comprising:
a robot manipulator comprising joints;
torque sensors disposed in the joints of the robot manipulator; and
a control unit designed to implement a virtual force sensor on the robot manipulator, the virtual force sensor being used to determine an external wrench acting on the robot manipulator based on torques determined by the torque sensors in joints of the robot manipulator, wherein the robot manipulator is moved or guided manually in a plurality of poses, and in each of the poses the control unit is configured to:
apply a respective specified external wrench to the robot manipulator;
ascertain a respective estimate of the external wrench based on an inverted or pseudo-inverted of the transpose of the Jacobian matrix applicable to a current pose and based on an external torque vector, wherein the external torque vector is based on the torques determined by the torque sensors in the joints of the robot manipulator and is determined based on expected torques acting on the robot manipulator;
ascertain a respective cost function based on a norm of a difference between the ascertained respective estimate of the external wrench and the respective specified external wrench or based on a difference of a norm of the ascertained respective estimate of the external wrench and a norm of the respective specified external wrench;
ascertain a respective calibration function by minimizing the respective cost function, the respective calibration function being used to adjust an external wrench currently determined during subsequent operation; and
store the respective calibration function in a data set of all calibration functions with assignment of the respective calibration function to a respective pose for which the respective calibration function was ascertained.

12. The system according to claim 11, wherein the control unit is configured to:
specify a task for the robot manipulator;
analyze the task and identifying working points to be traveled when a task is carried out; and
select respective poses of the robot manipulator in such a way that a respective one of the working points and a reference point of the robot manipulator match each other in a respective pose.

13. The system according to claim 11, wherein the robot manipulator is a redundant robot manipulator and the estimate of the external wrench is ascertained using the pseudo-inverse of the transpose of the current Jacobian matrix for the respective pose of the robot manipulator.

14. The system according to claim 13, wherein at least for a subset of the plurality of poses of the robot manipulator, the control unit is configured to:
move the redundant robot manipulator in its null space over a plurality of poses;
determine a separate calibration function; and
store the calibration function for each of the plurality of poses.

15. The system according to claim 11, wherein the respective cost function is minimized by a gradient-based method.

16. The system according to claim 11, wherein the respective cost function is minimized by a genetic method or an evolutionary method.

17. The system according to claim 1, wherein the application of the specified external wrench to the robot manipulator takes place by suspending a load having a specified mass to the robot manipulator.

18. The system according to claim 11, wherein the application of the specified external wrench to the robot manipulator takes place by connecting a mechanical spring of the robot manipulator to a support in such a way that the mechanical spring is pre-tensioned and exerts a force on the robot manipulator.

19. The system according to claim 11, wherein the application of the specified external wrenches on the robot manipulator takes place by moving the robot manipulator, so that specified accelerations due to inertial mass of the robot manipulator take place on the robot manipulator.

20. The system according to claim 11, wherein the control unit is configured to:
generate a pose-dependent calibration function from the data set of all the calibration functions by selecting a specific calibration function associated with a respective current pose of the robot manipulator or by generating an interpolation from at least two specific ones of all the calibration functions, wherein respective poses of the at least two specific ones of the calibration functions are closest to the respective current pose of the robot manipulator; and
apply the pose-dependent calibration on a currently determined external wrench acting on the robot manipulator.
